(19) United States
(12) Patent Application Publication
(10) Pub. No.: US 2024/0086736 A1
(43) Pub. Date: Mar. 14, 2024

(54) FAULT DETECTION AND MITIGATION FOR AGGREGATE MODELS USING ARTIFICIAL INTELLIGENCE

(71) Applicant: DataRobot, Inc., Boston, MA (US)

(72) Inventors: Edward Kwartler, Maynard, MA (US); Jett Oristaglio, New York, NY (US); Sarah Khatry, New York, NY (US); Haniyeh Mahmoudian, Vancouver, WA (US); Scott Lindeman, Boston, MA (US); Oleksandr Bagan, Kyiv (UA); Vlad Vovk, Kyiv (UA); Wesley Hedrick, Los Angeles, CA (US); Kent Borg, Los Angeles, CA (US); Alex Shoop, New Haven, CT (US); Nikita Striuk, Kyiv (UA); Gianni Saporiti, Marietta, GA (US); Alisa Zosimova, Kyiv (UA); Oleksandr Pikovets, Kyiv (UA); Anton Bogatyrov, Kyiv (UA)

(73) Assignee: DataRobot, Inc., Boston, MA (US)

(21) Appl. No.: 18/512,242

(22) Filed: Nov. 17, 2023

Related U.S. Application Data
(63) Continuation of application No. PCT/US2022/029400, filed on May 16, 2022.
(60) Provisional application No. 63/189,669, filed on May 17, 2021.

(51) Int. Cl. G06N 5/022; G06F 11/07

(52) U.S. Cl. CPC G06N 5/022; G06F 11/0709; G06F 11/079

(57) ABSTRACT

A system can include a data processing system that can include memory and one or more processors to generate, by a first model trained using machine learning and compatible with first data having a first type and second data having a second type, a first metric based on the first data and indicating a first fault probability in a second model, generate, by the first model, a second metric based on the second data and indicating a second fault probability in a third model, determine, based on the first metric and the second metric, that an aggregate model that includes the second model and the third model satisfies a heuristic indicating a third fault probability in the aggregate model, and instruct, in response to a determination that the aggregate model satisfies the heuristic, a user interface to present an indication that the aggregate model satisfies the heuristic.

### CROSS REFERENCE RELATED TO APPLICATIONS

This application claims the benefit of priority under 35 U.S.C. § 120 as a continuation of International Patent Application No. PCT/US2022/029400, filed May 16, 2022, and designating the United States, which claims the benefit of priority under 35 U.S.C. § 119 to U.S. Provisional Patent Application Ser. No. 63/189,669, entitled “RISK DETECTION AND MITIGATION METHODS FOR ARTIFICIAL INTELLIGENCE SYSTEMS, AND RELATED METHODS AND APPARATUS,” filed May 17, 2021, the contents of such applications being hereby incorporated by reference in its entirety and for all purposes as if completely and fully set forth herein. The subject matter of the present disclosure is related to International Patent Application No. PCT/US2019/066381, titled METHODS FOR DETECTING AND INTERPRETING DATA ANOMALIES, AND RELATED SYSTEMS AND DEVICES and filed under Attorney Docket No. DRB-010WO on Dec. 13, 2019, International Patent Application No. PCT/US2021/018404, titled AUTOMATED DATA ANALYTICS METHODS FOR NON-TABULAR DATA, AND RELATED SYSTEMS AND APPARATUS and filed under Attorney Docket No. DRB-013WO on Feb. 17, 2021, and U.S. Provisional Patent Application No. 63/037,894, titled SYSTEMS AND METHODS FOR MANAGING MACHINE LEARNING MODELS and filed under Attorney Docket No. DRB-016PR on Jun. 11, 2020, each of which is hereby incorporated by reference herein in its entirety.

### TECHNICAL FIELD

The present disclosure generally relates to artificial intelligence (AI). Portions of the disclosure relate specifically to fault detection and mitigation for aggregate models using artificial intelligence.

### BACKGROUND

As systems grow increasing complex and demands for accuracy of predictions increase, the likelihood that mistakes may occur in predictions increases. Predictions for increasingly complex systems may become increasingly unreliable as the breadth of scenarios subject to prediction increase. Thus, there is a need for detecting mistakes in predictions arising in various scenarios, and for mitigating any risks that may arise in those scenarios.

### SUMMARY

A system can include a data processing system that can include memory and one or more processors to generate, by a first model trained using machine learning and compatible with first data having a first type and second data having a second type, a first metric based on the first data and indicative of a first probability of a fault in a second model. The system can generate, by the first model, a second metric based on the second data and indicative of a second probability of a fault in a third model. The system can determine, based on the first metric and the second metric, that an aggregate model that includes the second model and the third model satisfies a heuristic indicative of a third probability of a fault in the aggregate model. The system can instruct, in response to a determination that the aggregate model satisfies the heuristic, a user interface to present an indication that the aggregate model satisfies the heuristic.

A method can include generating, by a first model trained using machine learning and compatible with first data having a first type and second data having a second type, a first metric based on the first data and indicating a first probability of a fault in a second model. The method can generate, by the first model, a second metric based on the second data and indicating a second probability of a fault in a third model. The method can determine, based on the first metric and the second metric, that an aggregate model including the second model and the third model satisfies a heuristic indicating a third probability of a fault in the aggregate model. The method can instruct, in response to the determining that the aggregate model satisfies the heuristic, a user interface to present an indication that the aggregate model satisfies the heuristic.

A computer readable medium including one or more instructions stored thereon and executable by a processor to generate, by the processor with a first model trained using machine learning and compatible with first data having a first type and second data having a second type, a first metric based on the first data and indicative of a first probability of a fault in a second model. The computer readable medium can generate, by the processor with the first model, a second metric based on the second data and indicative of a second probability of a fault in a third model. The computer readable medium can determine, by the processor and based on the first metric and the second metric, that an aggregate model that includes the second model and the third model satisfies a heuristic indicative of a third probability of a fault in the aggregate model. The computer readable medium can instruct, by the processor in response to a determination that the aggregate model satisfies the heuristic, a user interface to present an indication that the aggregate model satisfies the heuristic.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1A is a diagram of a system for fault detection and mitigation for aggregate models using artificial intelligence, according to some embodiments.

FIG. 1B is a diagram of a system for fault detection and mitigation for aggregate models using artificial intelligence, according to some embodiments.

FIG. 2 is a flowchart of a method for fault detection and mitigation for aggregate models using artificial intelligence, according to some embodiments.

FIG. 3 is a flowchart of a method for fault identification, according to some embodiments.

FIG. 4 is a flowchart of a method for fault classification, according to some embodiments.

FIG. 5 is a flowchart of a method for determining fault severity and likelihood, according to some embodiments.

FIG. 6 is a flowchart of a fault mitigation method, according to some embodiments.

FIG. 7 is a block diagram of an example computer system.

FIG. 8 illustrates a method for fault detection and mitigation for aggregate models using artificial intelligence, according to some embodiments.

FIG. 9 illustrates a method for fault detection and mitigation for aggregate models using artificial intelligence, according to some embodiments.

FIG. 10 illustrates a method for fault detection and mitigation for aggregate models using artificial intelligence, according to some embodiments.

FIG. 11 illustrates a method for fault detection and mitigation for aggregate models using artificial intelligence, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

The term “user” may refer to an individual, group, organization or computer system that accesses (e.g., provides input data to, receives output data from, or otherwise interacts with) a particular computer system (e.g., a risk detection and/or mitigation system). In some cases, an intelligent agent (or users of an intelligent agent) may accesses a risk detection and/or mitigation system to detect risks associated with the operation of the intelligent agent and/or to mitigate such risks (e.g., by initiating corrective actions resulting in a trustworthy, risk-mitigated output from the intelligent agent).

The term “automatic,” “automatically” or “programmatic” may refer to any step or series of steps performed by a computer system (e.g., in response to receiving an input or other stimulus, as part of an automated decision workflow, etc.) without interaction by an outside entity.

The terms “data,” “content,” and “information” may be used interchangeably to refer to information that is gathered, received, transmitted or stored by a computer system. A computer system may receive data from another apparatus including servers, relays, routers, networks, cloud networks, etc. Data may be transmitted from one computer system to another directly or through intermediate devices (e.g., routers, servers, etc.).

The term “electronic notification,” “log” or “warning” may refer to electronic transmission of a data notification to a user. Examples may include but are not limited to storage in a database, emails, display modals, multi-media messages on user mobile devices, etc. In some cases, a notification, log, or warning may convey information regarding a detected risk (e.g., a the risk's, classification severity, and/or likelihood).

The term “substantially instantaneously” may refer to real-time or near real-time transmission of information. In some embodiments, risk detection and/or mitigation may be performed in a substantially faster manner than previously possible using manual interventions.

The processes used to develop intelligent agents suitable for carrying out specific tasks generally includes steps of data collection, data preparation, feature engineering, model generation, and/or model deployment. “Automated machine learning” technology may be used to automate significant portions of the above-described process of developing intelligent agents. In recent years, advances in automated machine learning technology have substantially lowered the barriers to the development of certain types of intelligent agents (e.g., intelligent agents incorporating data analytics tools or machine learning models), particularly those that operate on time-series data, structured or unstructured textual data, categorical data, and/or numerical data. As used herein, “automated machine learning platform” (e.g., “automated ML platform” or “AutoML platform”) may refer to a computer system or network of computer systems, including the user interface, processor(s), memory device(s), components, modules, etc. that provide access to or implement automated machine learning techniques.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature's data type is categorical if the set of values that can be assigned to the feature is finite.

As used herein, “time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.). As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

“Computer vision” generally refers to the use of computer systems to analyze and interpret image data. Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), high-level (e.g., objects, scenes, events, etc.), or highest-level. The lower level features tend to be simpler and more generic (or broadly applicable), whereas the higher level features to be complex and task-specific. The detection/segmentation function may involve selection of a subset of the input image data (e.g., one or more images within a set of images, one or more regions within an image, etc.) for further processing. Models that perform image feature extraction (or image pre-processing and image feature extraction) may be referred to herein as “image feature extraction models.”

Collectively, the features extracted and/or derived from an image may be referred to herein as a “set of image features” (or “aggregate image feature”), and each individual element of that set (or aggregation) may be referred to as a “constituent image feature.” For example, the set of image features extracted from an image may include (1) a set of constituent image feature indicating the colors of the individual pixels in the image, (2) a set of constituent image features indicating where edges are present in the image, and (3) a set of constituent image features indicating where faces are present in the image.

Intelligent agents (e.g., automated decision systems) can be utilized in various channels, verticals and applications. Conventional intelligent agents can reinforce historical biases present in their training data, elicit unintended risks, or have unforeseen consequences. The inventors have recognized and appreciated that a system (e.g., a machine learning system) for detection and/or mitigating risks associated with the operation of an intelligent agent can help to identify risk presence based on the underlying data driving an intelligent agent's decision, classify the risk severity and likelihood, and take appropriate corrective action, resulting in a risk-mitigated trustworthy automated decision. In this way, a risk detection and/or mitigation system can significantly improve the effectiveness and acceptance of intelligent agents.

“Artificial intelligence” (AI) can encompass technology that demonstrates intelligence. Systems (e.g., computer systems executing software) that demonstrate intelligence may be referred to herein as “artificial intelligence systems,” “AI systems,” or “intelligent agents.” An intelligent agent may demonstrate intelligence, for example, by perceiving its environment, learning, and/or solving problems (e.g., taking actions or making decisions that increase the likelihood of achieving a defined goal). Intelligent agents can be developed by organizations and deployed on network-connected computer systems so users within the organization can access them. Intelligent agents can guide decision-making and/or to control systems in a wide variety of fields and industries, e.g., security; transportation; fraud detection; risk assessment and management; supply chain logistics; development and discovery of pharmaceuticals and diagnostic techniques; and energy management. Like intelligent organisms, intelligent agents can make mistakes (e.g., draw incorrect inferences from available data, make erroneous forecasts or predictions, etc.), particularly when presented with flawed data (e.g., data produced by a malfunctioning sensor, corrupted by an unreliable communication network, tampered with by a malicious actor, etc.) or unfamiliar data (e.g., a dataset that is dissimilar from datasets the intelligent agent has processed in the past).

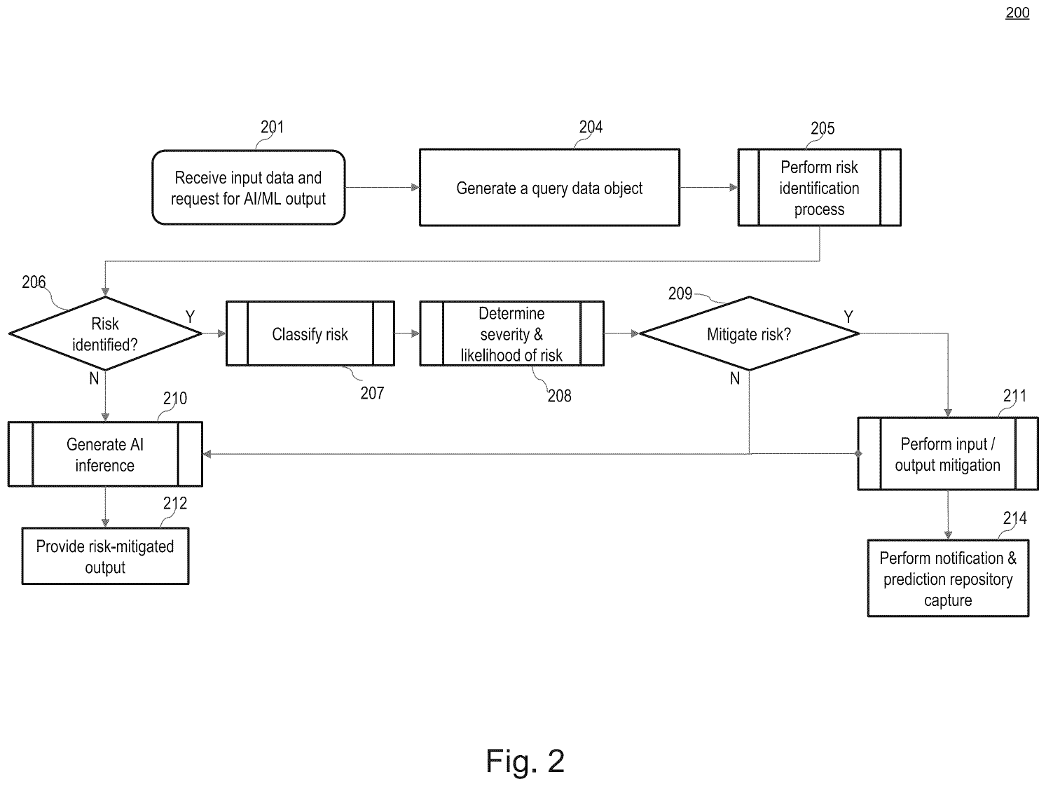

Disclosed herein are some embodiments of a system for detecting and/or mitigating risks associated with the operation of the intelligent agent. In some embodiments, risk detection and/or mitigation techniques may be implemented as or integrated into a mobile based application (“app”), cloud-edge prediction server, ambient human computer integration (for example, “voice activated smart speaker”) and/or Internet based portal for decision integration. In some embodiments, risk detection and/or mitigation techniques may be used in or integrated with an intelligent agent. A system that includes an intelligent agent and uses risk detection and/or mitigation techniques as described herein may be referred to as a “humble” or “risk-mitigated” intelligent agent, AI system, automated decision system, machine learning system, etc. In some embodiments, a risk-mitigated intelligent agent may provide a risk assessment and/or a risk-mitigation recommendation with respect to an inference (e.g., a forthcoming inference) of the intelligent agent. The risk assessment and/or risk mitigation recommendation may be distinct from the inference (e.g., prediction, predictive outcome, decision, etc.) provided by the intelligent agent. In some embodiments, a risk-mitigated intelligent agent may provide a “risk-mitigated inference,” for example, an inference that has been adjusted to mitigate a detected risk. In some embodiments, a risk assessment, risk-mitigation recommendation, or risk-mitigated inference can be based on one or more machine learning models, risk detection heuristics, and/or risk mitigation actions. An example of a method 200 for detecting and/or mitigating risks associated with the operation of an intelligent agent is shown in FIG. 2.

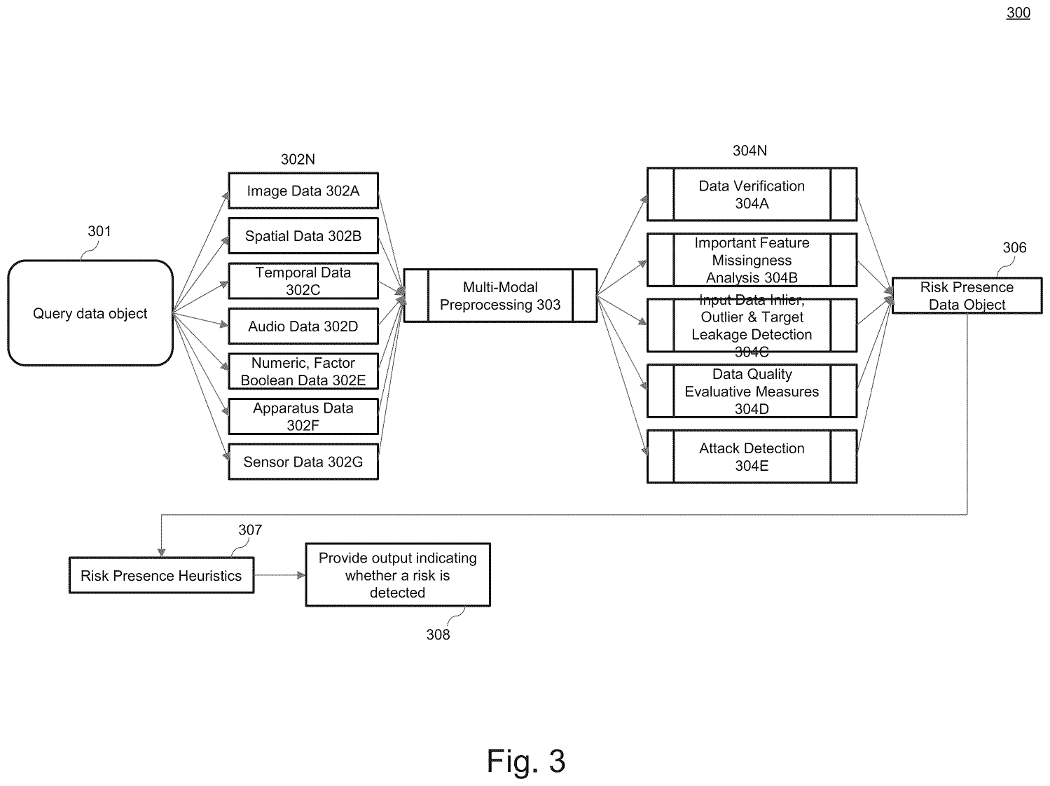

In various embodiments, a risk detection and/or mitigation system may determine that an input to an intelligent agent exhibits one or more indicia of risk (e.g., the input is invalid, does not meet integrity heuristics, has a high probability of comprising faulty information, demonstrates target leakage, etc.). This determination may be made pursuant to a risk identification method 300 as shown in FIG. 3. The input to the risk identification method 300, which may be referred to herein as “risk assessment input data” or a “risk assessment input data object”, may include the input to the intelligent agent (e.g., a query, inference record, scoring record, etc.) and/or any other suitable information (e.g., policy data indicative of the system's risk management policies; the training data and/or validation data used to train and/or validate the intelligent agent's ML model, or data describing aspects of the training data and/or validation data); etc.). The output of the risk identification method 300 may be referred to herein as “risk presence data” or as a “risk presence data object” (e.g., a multi-dimensional risk presence data object).

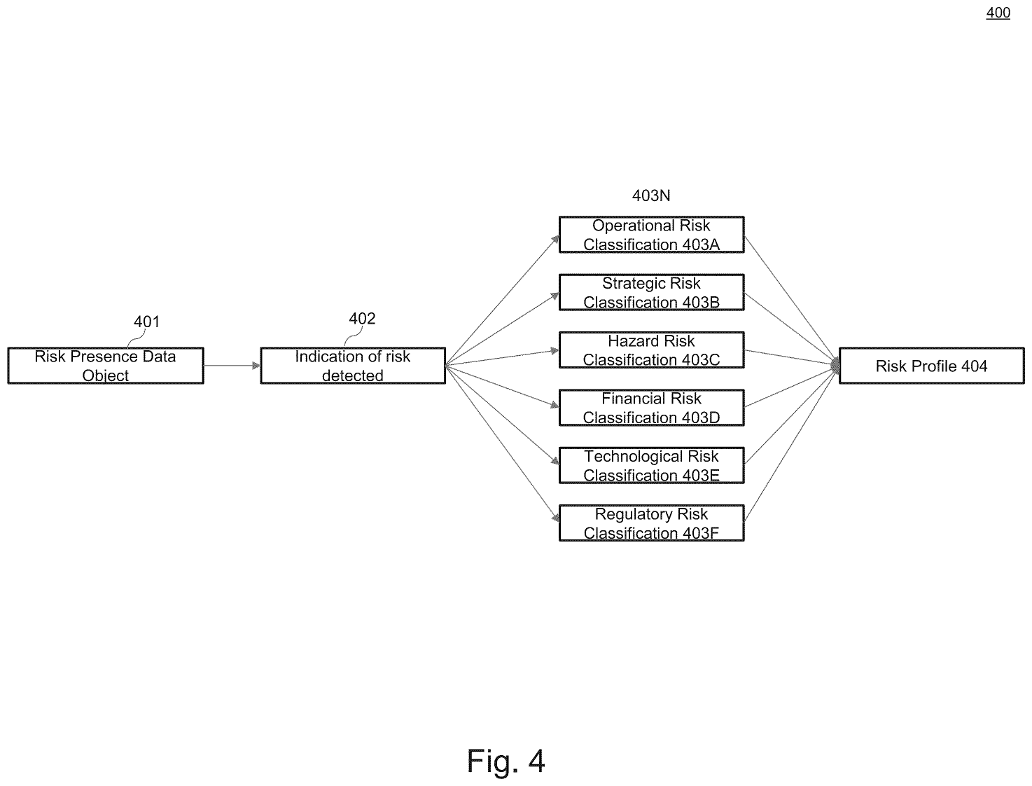

In some embodiments, a risk detection and/or mitigation system can classify the risks indicated by the identified indicia of risk into specific categories including but not limited to Operational, Strategic, Hazard, Financial, Technological or Regulatory risk. This classification may be performed using one or more machine learning models. An example of a risk classification method 400 is shown in FIG. 4. The input to the risk classification method 400 may include the risk presence data object. The output of the risk classification method 400 may include a risk profile (e.g., multidimensional risk profile) for the intelligent agent's forthcoming inference (e.g., decision), which may indicate the various classes of risks associated with the intelligent agent's forthcoming inference.

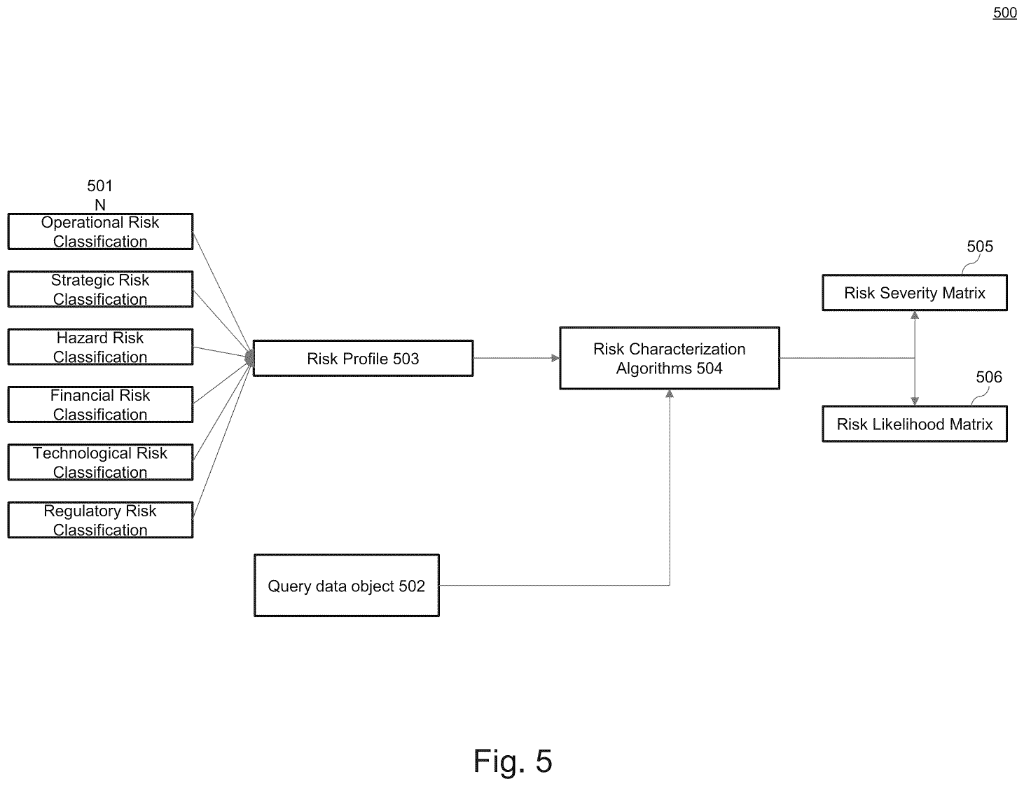

In some embodiments, a risk detection and/or mitigation system can determine the severity and/or likelihood of each of the identified classes of risk. These determinations can be made using one or more machine learning models (e.g., based on the risk profile, the risk data object, and/or other suitable data). An example of a method 500 for assigning a severity and/or a likelihood to each risk type is shown in FIG. 5. The output of the method 500 for assigning severity and/or likelihood to risk types may include a risk severity matric and/or a risk likelihood matrix.

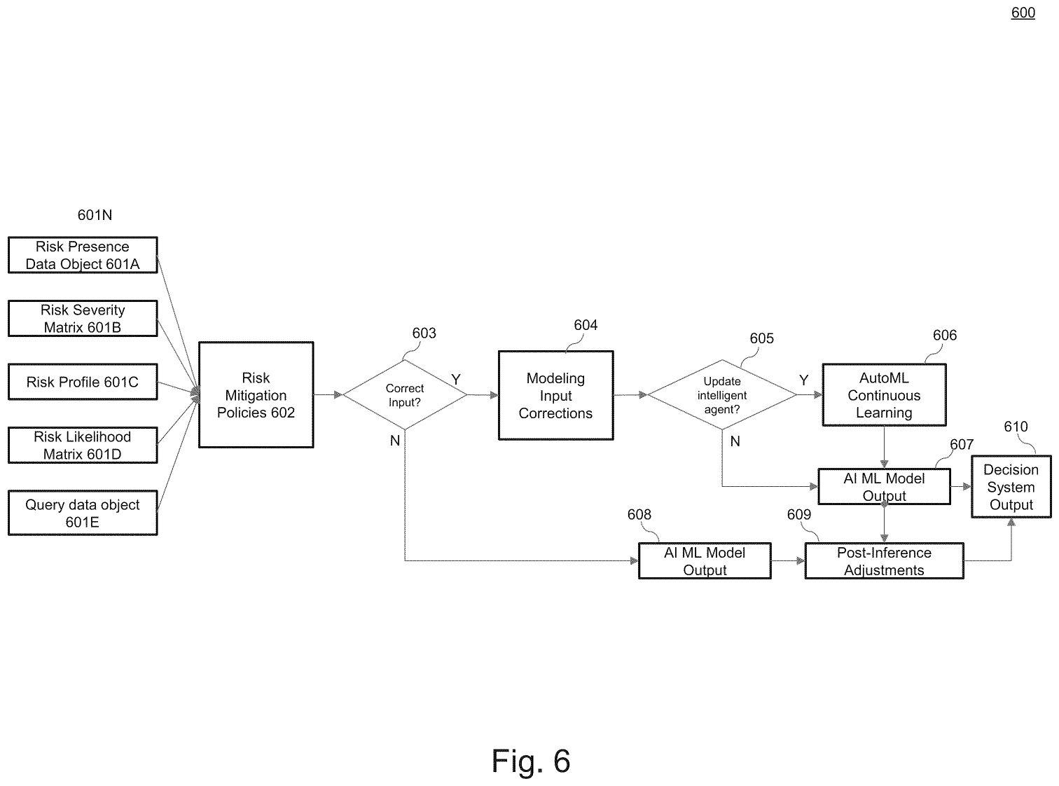

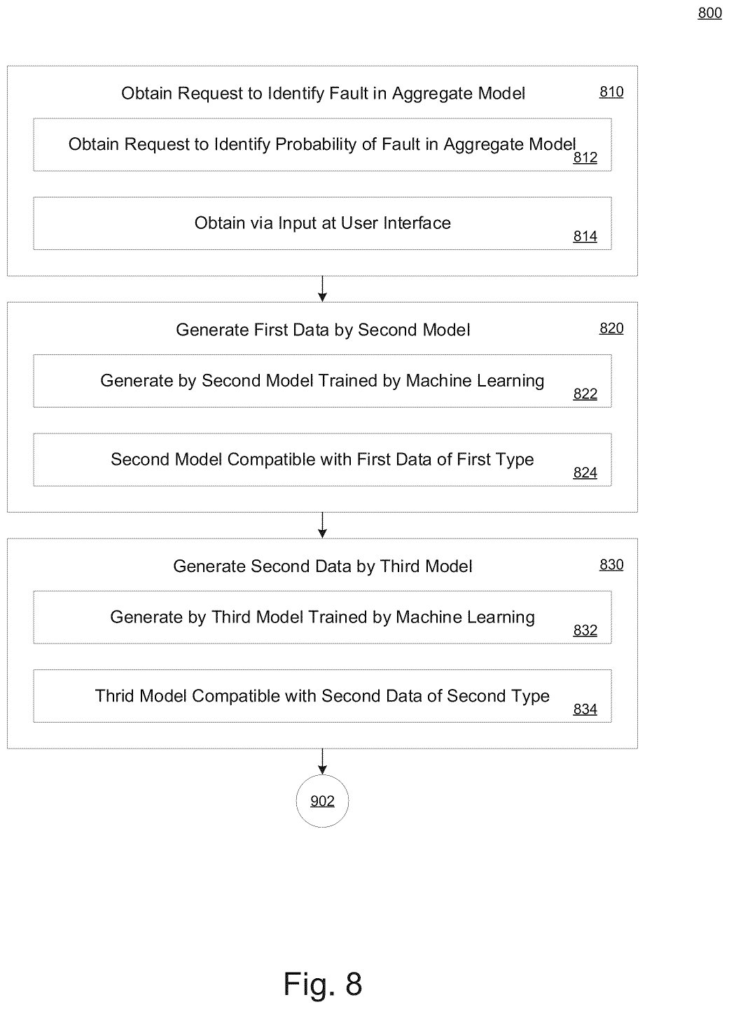

In some embodiments, a risk detection and/or mitigation system can perform one or more risk mitigation actions to mitigate the detected risk(s). An example of a risk mitigation method 800 is shown in FIG. 8. The inputs to the risk mitigation identification method 600 may include the risk presence data object, risk profile, risk severity matrix, risk likelihood matrix, and/or the risk assessment input data. Such input can be reviewed against one or more heuristics as shown in FIG. 6. Using human based input, heuristics, and/or an automated algorithms, a determination can be made whether (and how) to adjust a data input associated with an identified risk (e.g., a severe and likely risk). If an input is adjusted, the risk detection and/or mitigation system may determine whether the adjustment is sufficient to decrease the likelihood or severity associated with the forthcoming decision. In some instances, the system may instantiate an automated machine learning retraining before scoring the adjusted data utilizing an alternative model that demonstrates less risk (e.g., less bias) and increases predictive stability.

In addition or in the alternative, a determination can be made whether (and how) to change an inference (e.g., a modeling outcome) generated by intelligent agent before the inference is provided to the decision workflow. In some embodiments, a risk detection and/or mitigation system can adjust the intelligent agent's inference regardless of the identification of specific risk types, likelihoods or severities. For example, the system may perform an automatic post-inference adjustment based on metadata associated with the inference request, data inputs, heuristics identifying outlier predictions or classifications, low observation history, etc. Such a post-inference adjustment can improve the improve the inference by adjusting for biases, correcting an outlying inference, etc.

As described above, the risk detection and/or mitigation system may adjust inputs to an intelligent agent and/or adjust the output (e.g., inference) provided by an intelligent agent. In addition or in the alternative, in response to detecting a risk (e.g., a risk of a particular type, severity, and/or likelihood), the risk detection and/or mitigation system may provide a warning message, trigger an error condition, or limit the operation of the intelligent agent (e.g., disable the intelligent agent, disable certain functionality of the intelligent agent, prohibit the downstream use of the inference(s) associated with the risk, etc.) until a user authorizes the removal of such limitations. In the latter case, limiting the operation of the intelligent agent can prompt a qualified user to examine the identified risk(s) and interpret the associated results, such that the intelligent agent's operation is governed using logic and systems outside the workflow described in FIG. 2.

According to some embodiments, the data submitted to an intelligent agent in connection with an inference request may include multidimensional arrays, matrices, and/or streaming data such that deep convolutional neural networks, extreme gradient boosted machines, ensemble methods or similar machine learning approaches can be utilized in various processes illustrated in FIG. 2. Further, additional data preprocessing as part of algorithm training can be applied (e.g., edge detection, imputation, response encoding, etc.) to aid in the identification of risk presence, type, severity and likelihood.

Systems for Risk Detection and/or Mitigation

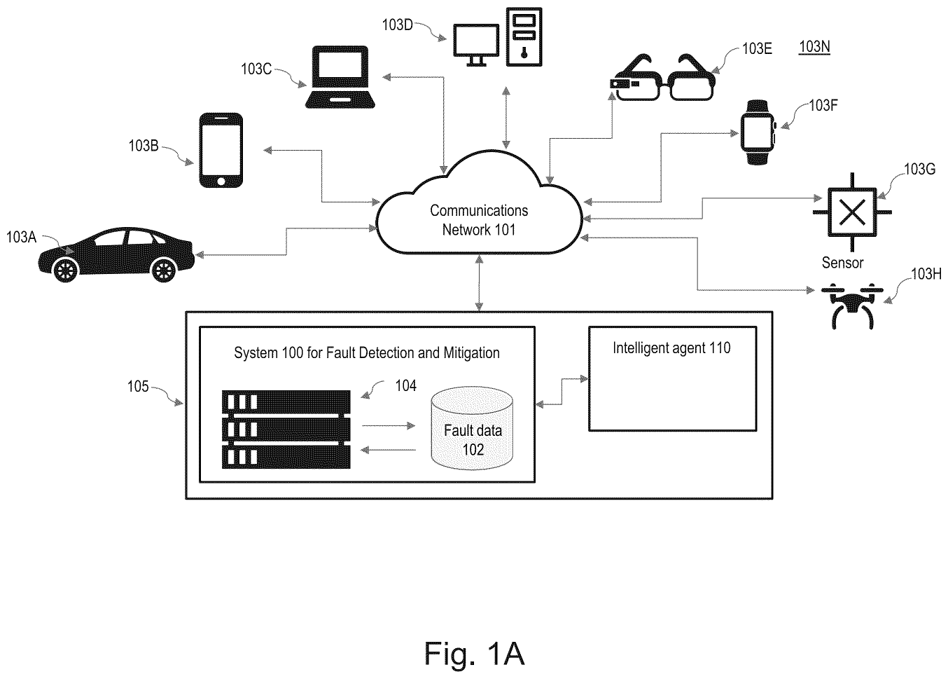

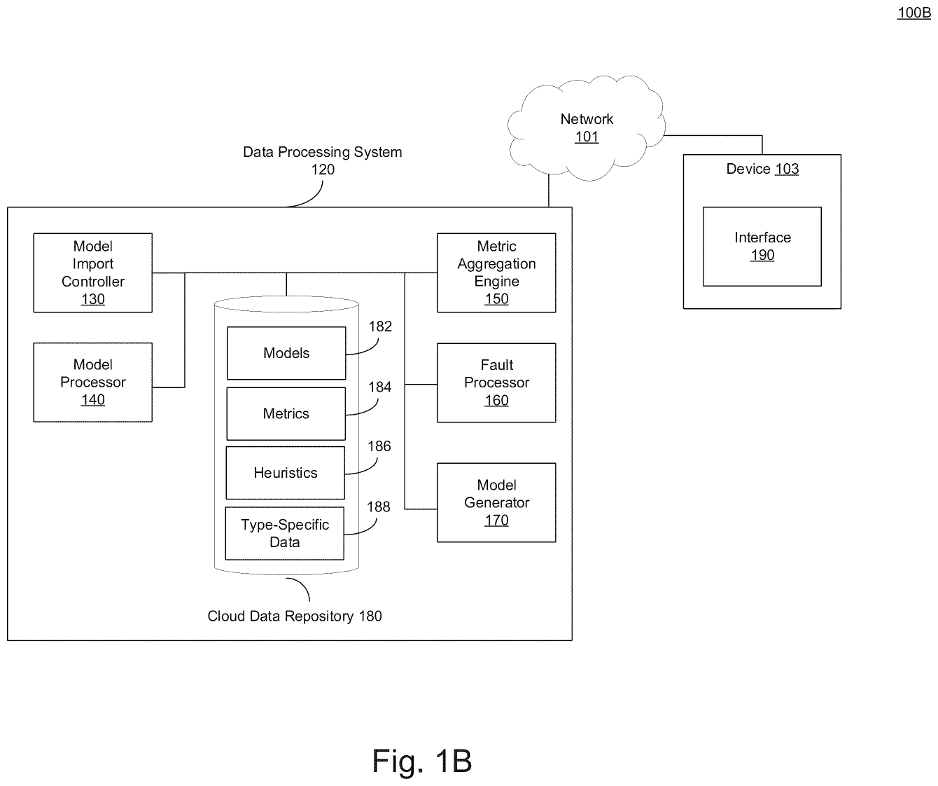

FIG. 1A illustrates a system 100 for risk detection and/or mitigation, according to some embodiments. The system 100 for risk detection and/or mitigation may be communicative coupled to or integrated with an intelligent agent 110. In combination, the intelligent agent 110 and the system 100 for risk detection and/or mitigation 100 may be referred to herein as a risk-mitigated intelligent agent 105.

In some embodiments, a client device 103 makes a request to the intelligent agent 110, seeking the intelligent agent's response (e.g., inference, prediction, classification, automated decision outcome, etc.). Accompanying data, metadata and internal information may be aggregated within the communications network 101 and routed to the system 100 for risk mitigation and/or detection, which may evaluate (e.g., substantially instantaneously evaluate) the incoming request for the presence of a risk. If the presence of a risk is detected, the system 100 may classify the specific risk, and may perform additional processing to ascertain the risk severity and risk likelihood. The incoming data request and the results of the risk analysis may be stored in a risk data repository 102 for auditing, continual machine learning and manual analysis. If no risk is present the system 100 may save the incoming data and risk analysis results in the risk data repository 102, and the intelligent agent 110 or the system 100 may transmit the agent's output (e.g., inference, prediction, classification or automated decision outcome) to the client device 103. If a risk is identified, the system 100 may store the incoming data and associated information in the risk data repository 102, and the intelligent agent 110 or the system 100 may transmit the agent's output (e.g., inference prediction, classification, automated decision outcome) and/or the output of the system 100 (e.g., warnings, adjustments, identified errors, etc.) to the client device 103.

FIG. 1A is illustrative of a computing system which includes an embodiment of a risk-mitigated intelligent agent 105. User devices may access the risk-mitigated intelligent agent 105 via a communications network 101. Authenticated access may be granted by or two various client apparatus labeled 103A-H (collectively, 103 or 103N).

The system 100 for risk detection and/or mitigation may include at least one server 104 and a risk data repository 102. The system 100 may use machine learning models and/or other suitable risk detection techniques to identify, classify and evaluate risks. Additionally, or alternatively, the communications network labeled 101 may aggregate device information or may pass individual device information to the risk-mitigated intelligent agent 105.

The communications network 101 may include one or more components including cable networks, cellular networks, public networks or private networks, which may be wired and/or wireless. The range of the communications network may be suitable for global, metropolitan, local area or personal area networks. Information may be carried over any suitable medium, for example, fiber optic, physical cable or satellite or any combination suitable for the transmission from the user device to the communications network ultimately to the risk-mitigated intelligent agent 105.

The server(s) 104 may include one or more computing devices capable of receiving data from one or more user devices 103. Additionally, the server(s) 104 may be able to transmit information to the user devices 103. The server may use machine learning models and/or other suitable risk detection techniques to identify, classify and evaluate risk of incoming device data and/or outgoing prediction outputs, and may save notifications and adjustment logs to the risk repository 102.

The risk data repository 102 may include a data storage device, e.g., a solid-state drive or magnetic disk. The risk data repository may retain information accessed, processed, adjusted, predicted, classified or evaluated by the server(s) 104 thereby facilitating the risk identification, classification, and evaluation (e.g., evaluation of risk severity, evaluation of risk likelihood, etc.) tasks of the system 100. For example, the risk data repository 102 may save multiple prediction inputs, requests, device data and user data associated with the request to the intelligent agent 110.

Data attributes facilitating a request to the intelligent agent 110 may be provided by devices 103 in various forms such as images, videos, strings, numeric, Boolean, factors, and/or any other suitable data types described herein, which may be captured in various formats including but not limited to JavaScript object notation (JSON), extensible markup language (XML), table and matrix data, audio (e.g., MP3), image (e.g., JPEG), and video (e.g., MP4) formats. Each user device 103 (e.g., vehicles, smartphones, laptop computers, desktop computers, connected wearable technologies, smart watches, sensors, unmanned automated vehicles, etc.) may contribute data individually or collectively to the communications network 101.

In some cases, a user device 103 may incorporate an application (e.g., “mobile app” or “app”) to facilitate data collection and transmission to the risk-mitigated intelligent agent 105 via the communications network 101. Users of tablets, smartphones, smart watches, etc. may use such an app to communicate with the risk-mitigated intelligent agent 105. Mobile applications may provide standardized methods of communication with one another and among other connected devices, e.g., Bluetooth connectivity to gather user inputs, device information and metadata including but not limited to the device location. These standardized workflows may share information with the communication network 101 via application program interfaces, “APIs.”

In some cases, users may interact with the risk-mitigated intelligent agent 105 via a web browser to gather, share and receive data and system outputs.

In some cases, user devices (e.g., sensors or autonomous systems) may send data to the risk-mitigated intelligent agent 105 and/or receive data from the risk-mitigated intelligent agent 105 (e.g., automated decision system outputs) without human intervention periodically, regularly (e.g., on a regular cadence), or intermittently. In some cases, such user devices and the agent 105 may stream data to each other continually.

The server 104 may process, store and analyze the incoming requests and data from client devices 103, and upload data to the risk data repository 102. The risk data repository 102 may be or include one or more repositories, databases, or storage devices, and may be part of the server 104 or a separate device.

The system 100 for risk detection and/or mitigation may detect the risks associated with input data for the intelligent agent 110 and/or with output data provided by the intelligent agent 110. If no risks are identified, or if risks are identified but the system 100 determines (e.g., based on the risk type, severity, and/or likelihood) that risk mitigation actions are not warranted, the output of the system 100 (e.g., risk classification, severity, and/or likelihood) and the output of the intelligent agent 110 (e.g., inference, prediction, and/or automated decision outcome) may be returned via the communications network 101 to the requesting user device 103.

If system 100 identifies one or more risks and determines (e.g., based on the risk type, severity, and/or likelihood) that risk mitigation is warranted, the risk-mitigated intelligent agent 105 may return an adjusted output (e.g., inference, prediction, classification or decision outcome), make an appropriate adjustment to the incoming data to mitigate or decrease the identified risk, provide a warning message, and/or trigger and error condition via the communications network 101 for dissemination to the user device 103.

The system 100 for risk detection and/or mitigation may include one or more modules configured to perform the risk detection and/or mitigation tasks described herein. In some embodiments, the system 100 includes a risk detection module and a risk mitigation module. Likewise, the intelligent agent 110 may include one or more modules configured to perform the functions of the intelligent agent. In some embodiments, the intelligent agent 110 includes an artificial intelligence and machine learning (AI/ML) module.

The risk detection module may be configured to process incoming data provided to the intelligent agent 110 and outgoing data provided by the intelligent agent 110. In some embodiments, The risk detection module is configured to perform the action of identifying outlier data, inlier data, data leakage, missing data and/or metadata associated with the presence, type, likelihood, and/or severity of a risk. The data processed by the risk detection module may be of any suitable type, including (without limitation) image, spatial, temporal (e.g., time-series), audio, numeric, factor, Boolean, etc. The data processed by the risk detection module may be provided by any suitable device or sensor. The data may be provided to the risk detection module in any suitable form, including (without limitation) raw or processed (e.g., feature extraction may have been performed on the data (e.g., edge detection in image data), signal processing may have been performed on the data (e.g., noise reduction in audio data), etc.

In some embodiments, the risk detection module is configured to detect the presence of risk based on incoming data to be scored by the AI/ML module and/or based on output data (e.g., inference data, predicted or classified values, etc.) provided by the AI/ML module. When a risk has been identified, the risk detection module may classify the type of risk and evaluate the severity and/or likelihood of the risk (e.g., based on probabilistic and/or heuristic-based risk classification and evaluation techniques).

In some embodiments, the risk mitigation module can adjust the incoming data to be scored by the AI/ML module, such that the severity and/or likelihood of the risk detected by the risk detection module is reduced. The techniques used to reduce the risk associated with incoming data may be selected based on the specific type of risk identified. Some examples of suitable techniques for adjusting the value of an input datum to reduce the risk associated with the input data may include algorithmic data imputation, outlier removal, heuristic based adjustments (e.g., imposing a user defined system limit on an incoming value), etc.

In some embodiments, the risk mitigation module can adjust the outgoing data provided by the AI/ML module, such that the severity and/or likelihood of a risk detected by the risk detection module is reduced. Some examples of suitable techniques for adjusting the value of an AI/ML module output (e.g., inference, prediction, classification, decision, etc.) may include algorithmic changes to decrease bias, reducing or increasing predicted values to values within observed validation data distributions, placing hard limits or floors on the values of the AI/ML module outputs (e.g., based on heuristics, machine learned models, and/or user systematic inputs), etc.

In some embodiments, the risk mitigation module can trigger an error condition or provide a notification (e.g., warning, alarm, etc.). Such action may be appropriate, for example, if an adjustment to incoming data or AI/ML module output that adequately mitigates the detected risk (e.g., reduces the risk likelihood and/or severity to acceptable levels) is not found. For example, if the AI/ML module produces an outlier predicted outcome even after an outlier input has been corrected, the risk mitigation module may trigger an error condition or provide a notification with or without the AI/ML module's output. Allowing this type of mitigation avoids a recursive loop in which the system 100 is unable to adequately mitigate a detected risk yet continually adjusts inputs and/or outputs in an effort to do so. In such cases, the system may ignore the input, provide the output as is, or block any output related to the input associated with the detected risk.

Fault Detection and/or Mitigation

FIG. 1B is a diagram of a system for fault detection and mitigation for aggregate models using artificial intelligence, according to some embodiments. As illustrated by way of example in FIG. 1B, an example system 100B can include the network 101, the user device or devices 103, and a data processing system 120. The system 100B can correspond at least partially in one or more of structure and operation to system 100 or any component or combination of components thereof.

The data processing system 120 can include a model import controller 130 to obtain one or more models that can be executed to generate output based on input data having one or more types. The data processing system can include a model processor 140 to execute one or more obtained models. The data processing system can include a metric aggregation engine 150 to combine one or more metrics into one or more aggregate metrics. The data processing system can include a fault processor 160 to obtain an aggregate metric and generate a fault indication associated with a model. The data processing system can include a model generator 170 to generate and update one or more models generated using machine learning. The data processing system can include a cloud data repository 180 to store one or more types and collections of data.

The model import controller 130 can obtain one or more models that can be executed to generate output based on input data having one or more types. The model import controller 130 can obtain a model from the cloud data repository 180 that satisfies one or more model criteria. The model import controller 130 can obtain multiple models, where one or more models can reference or be referenced by a another model. For example, the model import controller 130 can obtain an aggregate model from the cloud data repository 180, and identify one or more references within the aggregate model to a first model and a second model. The model import controller 130 can then import the first model and the second model based on the references to those models at the aggregate model. An aggregate model, for example, can include an arbitrary number of references, and any model can include an arbitrary number of references to an arbitrary number of models. The model import controller 130 can pass one or more obtained model to the model processor 140.

The model processor 140 can execute one or more models. The model processor 140 can identify one or more data sets that a model can receive as input, and can obtain the data sets from the cloud data repository 180. The model processor 140 can execute a model based on a particular framework associated with the model. For example, a model can be based on a machine learning framework, and the model processor 140 can execute the model in accordance with a machine learning framework or a regression framework compatible with the model. The model processor 140 can execute one or more models in parallel or in any distributed or concurrent process or processes. The model processor 140 can generate one or more metrics as output of one or more models. For example, the model processor 140 can generate a first metric as output of a first model, and can generate a second metric as output of a second model. The model processor 140 can generate the first metric that indicates a probability of a fault in the second model. A fault in a model can refer to, for example, a probability of presence of risk or presence of risk in a model or a model aggregating multiple models. For example, a fault can indicate that the input is invalid, does not meet integrity heuristics, has a high probability of comprising faulty information, or demonstrates target leakage, for example.

For example, the output of each risk detection analysis can comprise metrics defined as a binary classification indicating whether the presence of risk is detected. The output of each risk detection analysis can correspond to a separate metric. Thus, a first metric can correspond to an output of a risk detection analysis for a model compatible with a first data type. A second metric can correspond to an output of a risk detection analysis for a model compatible with a second data type different that the first data type. In some embodiments, the outputs of one or more (e.g., all) of the risk detection analyses are non-binary values (e.g., numeric values indicating the probability that a risk is present, based on the corresponding analysis). Each metric can thus indicate as a binary classification or as a numeric, scalar or like value, fault or risk for various models of an aggregate model. For example, the first and second metric can be organized into a risk presence data object 306 (e.g., a multi-dimensional risk presence data object).

The metric aggregation engine 150 can combine one or more metrics into one or more aggregate metrics. The metric aggregation engine 150 can receive as input the metric or metrics generated by the model processor 140, and can generate an aggregate metric based on a plurality of metrics. The metric aggregation engine 150 can generate the aggregate metric based on the references of the aggregate model to the first and second models, for example. The metric aggregation engine 150 can identify particular models referenced by the aggregate model, and can obtain the metrics corresponding to the output of those identified models. The metric aggregation engine 150 can then combine the obtained metrics to generate an aggregate metric corresponding to the aggregate metric. The aggregate metric can be descriptive of a fault or probability of fault associated with the aggregate model. The aggregate metric can be generated by the metric aggregation engine 150 as an object including or referencing one or more metrics, and one or more models. The object can include, for example, a JSON object or the like.

The fault processor 160 can obtain an aggregate metric and generate a fault indication associated with a model. The fault processor 160 can obtain an aggregate metric and can generate an indication of fault based on a probability of fault. The fault processor 160 can obtain a probability of fault from the metric aggregation engine 150 or can generate the probability of fault based on the metrics generated by the model processor 140 or the metric aggregation engine 150. The fault processor 160 can generate the probability of fault based on one or more heuristics indicating or defining conditions, thresholds, or states, for example, corresponding to a fault condition or a probability of a fault condition. For example, a heuristic can define a predetermined threshold corresponding to a particular probability of fault, that indicated a probability exceeding a predetermined reliability risk or acceptable failure rate for the model. The indication can be generated in a format compatible with a user interface of the user device 103.

The model generator 170 can generate and update one or more models generated using machine learning. The model generator 170 can generate or update a model based on input received at least from one or more repositories of the cloud data repository 180. The model generator 170 can generate one or more models using machine learning, and based on one or more training data sets or inference data sets. The model generator 170 can generate models or retrain model based on various input data, and can generate models associated with, restricted to, or optimized for generating metrics based on input data having a particular type or types. For example, the model generator 170 can generate a model optimized for image data, and can generate another model optimized for temporal data. The model generator can generate models, for example, optimized for data types 302A-N or 403A-N. The model generator 170 can include one or more hardware devices configured to execute particular machine learning operations, including, but not limited to, parallel processors and transform processors manufactured to execute particular operations rapidly.

The cloud data repository 180 can store one or more types and collections of data. The cloud data repository 180 can include model storage 182, metrics storage 184, heuristics storage 186, and type-specific data storage 188. The model storage 182 can store one or more models imported by the model import control 130 or generated by the model generator 170. The metrics storage 184 can store one or more metrics generated by the model processor 140 or the metric aggregation engine 150. The heuristics storage 186 can store one or more heuristics that the fault processor can obtain as input. The type-specific data storage 188 can store data in one or more type-specific structures. The type-specific data storage 188 can include one more portions storing data having particular type, or one or more structures indicating that a datum or data record of a data set, or a data set, corresponds to a particular data type. A data type can be a particular one or more of the data types 302A-N or 403A-N, for example.

The user device 103 can correspond at least partially in one or more of structure and operation to one or more of the devices 103, including devices 103A-H. The user device 103 can include an interface 190.

The interface 190 can provide one or more communications with the data processing system 120. The interface 190 can include a user interface presentable on a display device operatively coupled with or integrated with the user device 103. The display can present at least one or more user interface presentations and control affordances, and can include an electronic display. An electronic display can include, for example, a liquid crystal display (LCD), a light-emitting diode (LED) display, an organic light-emitting diode (OLED) display, or the like. The display device can be housed at least partially within the user device 103.

The interface 190 can communicatively couple the user device 103 to the data processing system 120 either directly or by the network 101. The interface 190 can communicate one or more instructions, signals, conditions, states, or the like with the user device 103. The interface 190 can include one or more digital, analog, or like communication channels, lines, traces, or the like. For example, the interface 190 can include at least one serial or parallel communication line among multiple communication lines of a communication interface. The interface 190 can include one or more wireless communication devices, systems, protocols, interfaces, or the like. The interface 190 can include one or more logical or electronic devices including but not limited to integrated circuits, logic gates, flip flops, gate arrays, programmable gate arrays, and the like. The interface 190 can include one or more telecommunication devices including but not limited to antennas, transceivers, packetizers, and wired interface ports. Any electrical, electronic, or like devices, or components associated with the interface 190 can also be associated with, integrated with, integrable with, replaced by, supplemented by, complemented by, or the like, the user device 103 or any component thereof.

In some aspects, the first data can be generated by the second model, and the second model trained using machine learning and compatible with the first type. In some aspects, the second data can be generated by the third model, and the third model trained using machine learning and compatible with the second type. In some aspects, the data processing system can generate an object that can include the first metric and the second metric and indicative of the first probability and the second probability. The system can provide the object to a fourth model as input. In some aspects, the data processing system can modify, in response to the determination that the aggregate model satisfies the heuristic, at least one of the second model and the third model. In some aspects, the fault in the second model can correspond to a drift in the second model, and the fault in the third model corresponding to a drift in the third model. In some aspects, the fault in the aggregate model can correspond to a drift in the aggregate model, and the heuristic corresponding to a predetermined drift in the aggregate model. In some aspects, the determination that the aggregate model satisfies the heuristic is performed by a fourth model trained using a machine learning model. In some aspects, the determination that the aggregate model satisfies the heuristic is performed by a fourth model can include a regression model. In some aspects, the data processing system can obtain, via the user interface, input indicative of a request to identify the fault in the aggregate model. The system can instruct the user interface to present the indication in response to the obtained input.

In some aspects, the method can include generating an object which can include the first metric and the second metric and indicating the first probability and the second probability. The method can provide the object to a fourth model as input. In some aspects, the method can include modifying, in response to the determination that the aggregate model satisfies the heuristic, at least one of the second model and the third model. In some aspects, the method can include obtaining, via the user interface, input indicating a request to identify the fault in the aggregate model. The method can instruct the user interface to present the indication in response to the obtained input. In some aspects, the first data can be generated by the second model, the second model can be trained using machine learning and compatible with the first type, the second data can be generated by the third model, and the third model can be trained using machine learning and compatible with the second type.

Referring to FIG. 2, a method 200 for risk detection and/or mitigation is presented, according to some embodiments. Automating risk detection and/or mitigation with some embodiments of the method 200 advances the stability of the outputs of an intelligent agent and improves the intelligent agent's trustworthiness, thereby enhancing the user experience and facilitating adoption and acceptance of intelligent agents.

At step 201, the risk-mitigated intelligent agent receives a request for an output (e.g., an AI/ML output). Data associated with inputs (e.g., independent variables) of a machine learning model of the intelligent agent may be captured and organized according to suitable protocols (e.g., JavaScript Object Notation (JSON), extensible markup language (XML), etc.). In some cases, supplemental data germane to the device(s) that provided the input data (e.g., device location, timestamps of device measurements, device statuses, etc.) are also captured. In some embodiments, such supplemental data may be used in conjunction with the input data to ascertain the presence of a risk. The client device initiating the request may transmit the input data (and, optionally, device data) to the risk-mitigated intelligent agent using any suitable technique (e.g., wired or wireless networks, authenticated API GET and POST requests, etc.).

At step 204, the system 100 may generate a query data object. The data object may include the request for AI/ML output, the input data, and the above-described device data. In some embodiments, the data object may include other data, for example, organizational policy data, applicable personally identified information of the user, system stored sensor or requesting device data attributes, the training data used to train the intelligent agent's ML model (or data derived therefrom), etc.

Still referring to FIG. 2, at step 205, a risk identification process can be performed. At step 206, if no risk has been identified, the system 100 can submit the query data object to the intelligent agent for scoring at step 210, and the intelligent agent's output may be provided to the requesting client device at step 212. The output (e.g., inference, prediction, classification, decision, etc.) may be unaltered given that no risk was detected an no risk mitigating adjustments were performed. In some embodiments, the provided output may include a digital signature and metadata indicating that no risk was detected. In this case, the system can rely on any suitable protocols of intelligent agents (e.g., machine learning system deployments) for monitoring, uptime guarantee or data drift detection among other standard practices.

Returning to step 206, if a risk is identified, the system 100 may classify the risk (step 207), determine the severity and likelihood of the risk (step 208), and optionally mitigate the risk (steps 209, 211, and 214). Some embodiments of the risk identification process (step 205), risk classification process (207), risk evaluation process (step 208), and risk mitigation process (steps 209, 211, and 214) are described in further detail below.

### Risk Identification Process

Referring to FIG. 3, a risk identification method 300 is presented, according to some embodiments. In some embodiments, the risk identification step 205 of the risk detection method 200 may be performed using the method 300 of FIG. 3. In some embodiments, the risk identification method 300 may produce a binary result (e.g., a binary classification) indicating whether or not a risk has been detected.

Referring to FIG. 3, the query data object 301 may include one or more types (e.g., modes) of data 302. At step 303, the query data object's data can be organized into a modeling matrix which may include data enrichment (e.g., edge detection data, color correction data, and/or pixel level analysis data for image data; response prevalence encoding (e.g., mean response encoding) for categorical or numerical data types; value imputation for missing data; term-frequency inverse-document frequency (TFIDF) for unstructured text data; and/or anomalous data detection). Other types of data enrichment are possible.

After the (optional) enrichment at step 303, the various modes of data can be subjected to one or more risk detection analyses 304, each of which may produce a binary result (e.g., binary classification) indicating whether or not a risk has been detected based on the type(s) of data analyzed. For example, at step 304A, a data verification analysis may be performed. The data verification analysis may involve authenticating the device that provided the query data. The client device (and the data provided thereby) can be classified as being authenticated (no risk detected) or the device that provided the data can be classified as being fictitiously constituted or “spoofed” (risk detected). In an example, the client device data can be authenticated via client certificate authentication, private key/public key authentication, or any other suitable authentication techniques.

At step 304B, an analysis can be performed to identify missing data in the query data object and determine whether the missing data is significant. In some embodiments, the determination as to whether the missing data are significant may be based on the feature importance of the feature(s) for which values are missing, the number of features for which values are missing, etc. For example, if a request is made with three of 10 input variables missing, the system may detect risk associated with the request at step 304B.

According to some embodiments, at step 304C, data quality checks other than the missing data check (step 304B) can be applied. In some examples, the data quality checks can include checking for data inliers, outliers, and/or target leakage. For example, target leakage may be detected at the variable level. In one example, if a variable that is identified as a target leakage variable during the training of the intelligent agent's ML model is discovered in the query data object, a risk associated with the data object may be detected. (During the mitigation phase, such a risk may be mitigated by removing the identified target leakage variable from the query data object). Use of standard statistical measures may indicate the current system request has outlier values compared to the model's original training data or other recent system requests. For example, historically an independent variable may have a range between 1 and 5, yet a new request may have the independent variable value set to 50 thereby being many standard deviations from the observed historical mean and distribution.

At step 304D, additional heuristics and/or algorithms may be applied to ascertain the quality of the input data being received by the risk-mitigated intelligent agent 105. In one embodiment, the quality of data may be evaluated based on data relating to the stability of the submitting sensor or user device. For example, if a sensor has previously given faulty data when submitting requests to the intelligent agent, the latest request can be considered faulty with a higher probability requests from a competing sensor or device. In some examples, the system 100 may track the history of faulty data provided by particular users (or devices). For example, the system 100 may track the volume of faulty data provided by particular users (or devices) over time, and/or the rate at which particular users (or devices) have provided faulty data over time. If the historical data indicate that a particular user (or device) is providing faulty data at a volume or rate that exceeds a risk threshold, any data provided by that user (or device) may elicit a determination that risk is present until the integrity of the user (or device) is reestablished. Such data quality evaluation measures can help the system identify patterns of fraud, abuse or defective client devices or sensors.

At step 304E, attack detection analysis is applied to the query data object. Intelligent agents are sometimes targeted by malicious actors for attacks (e.g., adversarial attacks, typographic attacks, model inversion attacks, memorization attacks, etc.) that can compromise the security, privacy, or operational integrity of an intelligent agent. At step 304E, conventional techniques for detecting such attacks may be applied. If such an attack is detected in connection with a query data object, the system 100 may detect the presence of risk for the data object.

In many cases, attacks on intelligent agents involve the fraudulent alteration of data submitted to the intelligent agent for scoring. For example, in machine vision systems, “adversarial attacks” may involve pixel level changes to input images that are made in an effort to trick a neural network, thereby producing an erroneous outcome. Adversarial attacks involving fraudulently altered data can also be performed on other data types (e.g., audio data, time-series data, image data, video data, etc. Anomalous data or obfuscated data (e.g., hidden text on a resume) may also be used in attacks.

In the above-described examples, the output of each risk detection analysis 304 is a binary classification indicating whether the presence of risk is detected. In some embodiments, the outputs of one or more (e.g., all) of the risk detection analyses are non-binary values (e.g., numeric values indicating the probability that a risk is present, based on the corresponding analysis).

Still referring to FIG. 3, the each of the risk detection analyses 304 may provide an binary output indicating whether a risk has been detected or the probability that a risk is present. In some embodiments, the five individual risk detection results can be organized into a risk presence data object 306 (e.g., a multi-dimensional risk presence data object).

At step 307, the risk presence data object can be evaluated using one or more risk detection heuristics and/or models (e.g., a regularized logistic regression model or other machine learning model trained on the historical risk propensities of the risk presence data object along with historical risk presence results. In some examples, a risk detection heuristic can include determining a weighted sum of the individual risk detection results, comparing the weighted sum to a threshold value, and determining that a risk is present if the weighted sum exceeds the threshold value. Other risk detection heuristics are possible. Consequently, at step 308, the risk identification method 300 may produce a single, binary risk classification indicating whether risk is present in the query data object.

### Risk Classification Process

Referring to FIG. 4, a risk classification method 400 is presented, according to some embodiments. In some embodiments, the risk classification step 207 of the risk detection method 200 may be performed using the method 400 of FIG. 4. The inputs to the risk classification method 400 may include, for example, the risk presence data object 401 produced by the risk identification method 300, the output 402 of the risk identification method 300 indicating whether or not a risk has been detected, and/or the query data object 301.

The risk classification method 400 may use one or more models (e.g., supervised machine learning models) to classify the detected risk. In some embodiments, a single multiple classification model can be used to classify the risk(s). In other embodiments, multiple individual models can be used to classify the risk(s) (e.g., one mode for each risk type).

In some embodiments, the models 403 can classify risks according to the output produced by the intelligent agent and the suspected impact of the risk on the agent's output. In one embodiment, the risk types can include operational risk, 403A, strategic risk, 403B, hazard risk, 403C, financial risk, 403D, technological risk, 403E, and/or regulatory risk, 403F.

For example, the operational risk classification model 403A, may identify a faulty sensor operation providing incorrect data in the machine learning request.

The strategic risk classification model 403B may identify risks that impact the organization providing or requesting the intelligent agent's output. For example, a strategic risk classification may identify data drift stemming from poorly maintained machinery within a machine learning and artificial intelligence system.

The hazardous risk classification model 403C may identify input data or intelligent agent output whereby a hazardous condition may arise, for example, the automated decision to change manufacturing machinery to a point the machine may fail or cause an adverse stakeholder impact.

The financial risk classification model 403D may identify financial risks. Given the profitability, efficiency or return on investment enabled by an automated machine learning system, a risk may entail outlier prediction that can reduce expected profitability, efficiency or other financial gain. For example, a credit prediction by a financial institution may be classified as risky if it would cause the transaction to be unprofitable given the credit offer or the credit prediction amount.

The technological risk classification model 403E may identify risks associated with the input or output system data as well as the policy, organizational or metadata contained within the risk presence data object 401. Technological risk may entail the identification of falsified or altered data (e.g., manipulated pixels in an image, anomalous policy data as a result of user fraud, or a series of data changes when taken in totality that provide a high likelihood of active technological subterfuge including but not limited to malware or viruses contained within the risk-mitigated intelligent agent 105 or connected components, etc.).

The regulatory risk classification model 403F may identify regulatory risks. The risk presence data object may be examined to identify algorithmic bias with respect to sensitive features. For example, the use of statistical parity, well calibration, or other methods may identify a bias based upon gender, race or age or other sensitive feature determined by regulation, policy or organizational requirements.

Some non-limiting examples of phenomena that may result in the risk classification models 403 detecting a particular type of risk may include extrapolation, bias and fairness inconsistencies, data drift, accuracy deterioration, and/or temporal failure.

At step 404, the classifications for each type of risk can be joined to create a risk profile data object indicating whether each type of risk has been detected.

### Risk Severity and Likelihood Determination Process

Referring to FIG. 5 a risk severity and likelihood determination method 500 is presented, according to some embodiments. In some embodiments, the risk severity and likelihood determination step 208 of the risk detection method 200 may be performed using the method 500 of FIG. 5. In one embodiment, given that a risk was identified in step 205, and the risk(s) were classified in step 207, the method 500 can be used to determine the likelihood and severity of each of the detected types of risk.

In some embodiments, the inputs to the risk severity and likelihood determination method 500 can include the risk profile 503 generated by the risk classification method 400 (e.g., risk profile 404) and the query data object 502 (e.g., query data object 301), both described previously.

In some embodiments, input data (e.g., query data object 502 and/or risk profile 503) can be subjected to risk characterization algorithms (e.g., classification algorithms, machine-learned models, etc.) to further characterize the detected types of risk. These algorithms can use the input data to determine a risk severity type and/or a corresponding likelihood classification. In some examples, a labeled set of training data can be used to train a risk severity classifier and risk likelihood classifier. In one example, a customer and/or user can provide the labeled set of training data (e.g., provide historical data including risk labels).

In some embodiments, the risk characterization algorithms 504 may classify risk severity as “Catastrophic”, “Critical”, “Marginal” or “Negligible.” Standard risk management and industry system safety engineering severity definitions may be used. In one example, risk severity classifications as described within the Department of Defense MIL-STD-882E System Safety Standard for environment, safety, and occupational health risk management methodology for systems engineering may be used. In some embodiments, severity definitions may be adjusted by the system 100 (e.g., based on organizational policy). For example, a “Catastrophic” risk can include one that may result in death or significant financial loss. In contrast, a “negligible” risk hazard may result in lost productivity or minimal financial impact. Thus, in one example, the system 100 can automatically classify the risk severity (e.g., using the Department of Defense MIL-STD-882E System Safety Standard described above) based on input data.

In some embodiments, the risk likelihood algorithms 504 may classify risk likelihood as “Frequent”, “Probable”, “Occasional”, “Remote”, “Improbable” or “Eliminated.” Standard risk management and industry system safety engineering levels may be used. In an example, the risk likelihood classifications as described within the Department of Defense MIL-STD-882E System Safety Standard for environment, safety, and occupational health risk management methodology for systems engineering can be used. Likelihood probability types and definitions may be adjusted by the system 100 (e.g., based on organizational policy). For example, a “Frequent” likelihood can include one that is continually experienced by the system. A Frequent risk may arise from a faulty sensor continually providing incorrect readings among multiple system requests. Another example may include an “Improbable” likelihood, indicating that the risk is unlikely to occur yet remains possible. In practice, an Improbable risk may include a machine learning system being subjected to an adversarial attack. In some embodiments, the system 100 may determine an incoming request is part of an adversarial machine learning attack but it is unlikely given existing system security. Thus, in one example, the system 100 can automatically classify the risk likelihood (e.g., using the Department of Defense MIL-STD-882E System Safety standard described above) based on input data.

A risk severity classification can be attributed to each risk type in a risk severity matrix 505. For example, an “Operational Risk” may be classified as “Catastrophic”. A risk likelihood classification can be attributed to each risk type in a risk likelihood matrix 706. For example, a “Regulatory Risk” may be classified as “Probable”.

### Risk Mitigation Process

Referring to FIG. 6, a risk mitigation method 600 is presented, according to some embodiments. In some embodiments, the risk mitigation steps (209, 211, 214) of the risk detection and/or mitigation method 200 may be performed using the method 600 of FIG. 6. In some embodiments, the inputs to the risk mitigation method 600 may include a risk presence data object 601A (e.g., risk presence data object 306), a risk severity matrix 601B (e.g., risk severity matrix 505), a risk profile 601C (e.g., risk profile 404), a risk likelihood matrix 601D (e.g., risk likelihood matrix 506), and/or a query data object 601E (e.g., query data object 301).

In one embodiment, at step 602, the system 100 may evaluate the input data 601 in accordance with risk mitigation policies. For example, a data “Compliance” risk may be identified, then determined to be “Probable” and “Catastrophic” (e.g., in the case of an intelligent agent that extends credit differently based on the borrower's gender). In some embodiments, given these characteristics, the risk mitigation policies 602 can indicate corrective measures.

Any suitable risk mitigation policies may be used. In some examples, the risk mitigation policies may include if-then contingency statements of the form if {risk-related contingency is detected} then {perform specified mitigation action} (e.g., if {risk type is compliance, risk likelihood is probable, and risk severity is catastrophic} then {disable the intelligent agent}. Such risk mitigation policies may be provided by the user, and may be programmatically integrated into the system 100 for risk detection and/or mitigation. In some examples, the risk mitigation policies may be learned by applying supervised machine learning techniques to labeled data sets provided by the user.

In some embodiments, application of the risk mitigation policies to the input data 601 may indicate whether or not correcting an input to the original request can mitigate the detected risk. In some examples, application of the risk mitigation policies can include checking for outliers within the input data based on historical training data. In one example, if outlying input data is found and/or if data drift is detected a corrective action can include adjusting the outlying data value to be closer to the mean value for the input variable in question (e.g., moving the outlying data value within one or two standard deviations of its mean value, etc.). In some embodiments, after adjusting an input value, the system may assess the effects of the adjustment by prompting the intelligent agent 110 to generate an inference based on the adjusted input data and (1) assessing the risk associated with the adjusted input data to determine whether the risk has decreased, and/or (2) determining, based on the validation data for the intelligent agent, whether the inference is an inlying inference (generally indicating low risk or no risk) or an outlying inference (possibly indicating a non-negligible risk).

In some examples, application of the risk mitigation policies can include prioritizing correction of values for input variables having relatively high feature importance values. For example, the risk mitigation policy may dictate that the system 100 considers or implements value adjusts first with respect to the variables that have outlying values and high feature importance. In some embodiments, the user can be alerted when the system 100 adjusts any of the input data values.

At step 604, one or more input value adjustments dictated by the risk mitigation policies 602 may be performed. Such adjustments may include but are not limited to reweighting the offending data value and rescoring the request using the intelligent agent. For example, given a “Financial” risk with high severity and likelihood, a risk mitigation policy may dictate an adjustment for an input variable such as the borrower's income. In an example, performing an adjustment for the value of a particular variable can include moving the value of the variable from an outlying value toward a mean value for the variable. The mean value may be determined, for example, based on data from a training set for the intelligent agent.

As is often the case with manually entered data, numeric transpositions may cause outliers that get extrapolated by machine learning systems. The above-described techniques for correcting modeling inputs are indicative of a systemic ability to correct the input to a normalized or expected value. In doing so, the risk-mitigated intelligent agent 105 may exhibit humility when making predictions.

In one embodiment, at step 605, the system 100 may determine whether or not the adjustment made at step 604 denotes a systemic issue or is isolated to the single system request. For example, an intelligent agent monitoring system may detect data drift after data provided by a particular sensor has led to multiple modeling input corrections in series as opposed to an isolated request that leads to a single correction. In some examples, drift detection by the system can include detecting N consecutive instances of data from a particular device that the system classifies as exhibiting any risk of a particular type of (e.g., risk of at least a threshold level of severity and a threshold level of likelihood; risk for which the system's risk mitigation heuristics direct the system to adjust the input or the output to account for the risk of error in the input, etc.), where N>1. More generally, drift detection by the system can include detecting at least a specified amount of data from a particular device (e.g., number of data instances, time rate of data instances, proportion of data instances, etc.) that the system classifies as exhibiting risk (e.g., any risk or a particular type of risk) within a specified time period and/or within a specified number of data instances provided by the particular device. Other techniques for detecting drift in the data provided by a particular device or set of devices are possible, including (but not limited to) the techniques described in International Patent Application No. PCT/US2019/066381, International Patent Application No. PCT/US2021/018404, and U.S. Provisional Patent Application No. 63/037,894, each of which is incorporated by reference herein. In some examples, drift detection by the system can include detecting the velocity (e.g., rate of change) of any identified data of potential risk. The system's approaches to detecting data drift and mitigating the risks associated with data drift may be dictated by system protocols and/or user-specified policies. In some examples, the criteria for distinguishing between systemic issues and/or isolated issues can be parameterized and/or configured to implement a user's risk mitigation preferences.

When a systemic failure is identified, a corrective action utilizing automated machine learning can be enacted such that a new machine learning model is created and replaces the original model (e.g., according industry standards for “continuous learning”) (step 606). In some examples, a copy of the original model, referred to herein as the copied model, can be created and a “refresh” of the copied model can be performed, e.g., the copied model can be retrained using new data to adjust the copied model's parameter values. In contrast, in one example, a new model can be trained from scratch using new data. In doing so, the replacement machine learning model can automatically identify patterns so as to address the system issue previously identified. For example, a replacement model can correctly diminish the importance of a faulty sensor among other data sources because the sensor's readings will have a weaker relationship to the predicted outcome.

In one embodiment, at step 607, the updated model stemming from a system update utilizing continuous learning scores the data object with or without further value corrections.

If an input data correction is determined to be a singular (non-systemic) issue, then the original machine learning or artificial intelligence model output can be retained (step 607).

In some embodiments, the system 105 may determine, based on the incoming data objects and accompanying heuristics, that the detected risk does not warrant further mitigation (e.g., data correction). For example, a model predicting a digital advertisement click may be determined to have a risk with type “Financial”, and likelihood “Probable” but the corresponding risk severity may be “Negligible” given that a single digital advertisement may cost very little. Thus, the system 105 may determine 603 that the data can be provided to the intelligent agent 110 to generate an inference without alteration (step 608). In some examples, the mitigation actions can be user defined and/or, as described above, determined based on the incoming data objects and/or associated heuristics.

At step 609, inferences generated by the intelligent agent 110 may be subjected to post-inference adjustments to mitigate risk. In some cases, it is beneficial to adjust predictions or classification outcomes (in addition to or as an alternative to adjusting inputs) to mitigate risk. For example, a prediction generated by a healthcare model indicating a probability of hospital readmission may be adjusted to account for algorithmic bias based on race, gender or age. In this case, adjusting the output may be preferential to providing a corrective input (e.g., an input in which the patient's race is changed) to decrease the model's bias because the patient record may be subject to laws and regulations that preclude alterations to the data in the patient record. Instead, adjustments to alleviate identified algorithmic bias can be applied directly to the model's output. In some examples, techniques for adjusting the intelligent agent's inference to account for algorithmic bias can include re-weighting an original training data set and/or adjusting the agent's inferences to account for statistical parity, etc.

In some examples, at step 610, the system 100 can check the intelligent agent's output value to determine whether the output value includes outlier data relative to a validation data set. In one example, a correction and/or corrective action can include running a corrected packet through the system and subsequently checking to see if the corrected packet has been flagged as a risk and/or has produced an expected result.

At step 610, the system can provide an output. The output can include an inference, prediction, and/or classification facilitating an automated decision. In some embodiments, the output includes the risk presence data object 601A, the risk severity matrix 601B, the risk profile 601C, the risk likelihood matrix 601D, the query data object 601E, the output of the intelligent agent 110 (1) without corrective value input (see step 608) (2) with corrective value input (see step 607), or (3) after continuous learning has updated the intelligent agent (see step 606), and when applicable, a classification or prediction value with post prediction model adjustments applied, 609. The output can be utilized within an automated decision-making process that includes machine learning or artificial intelligence.

### Computer-Based Implementations

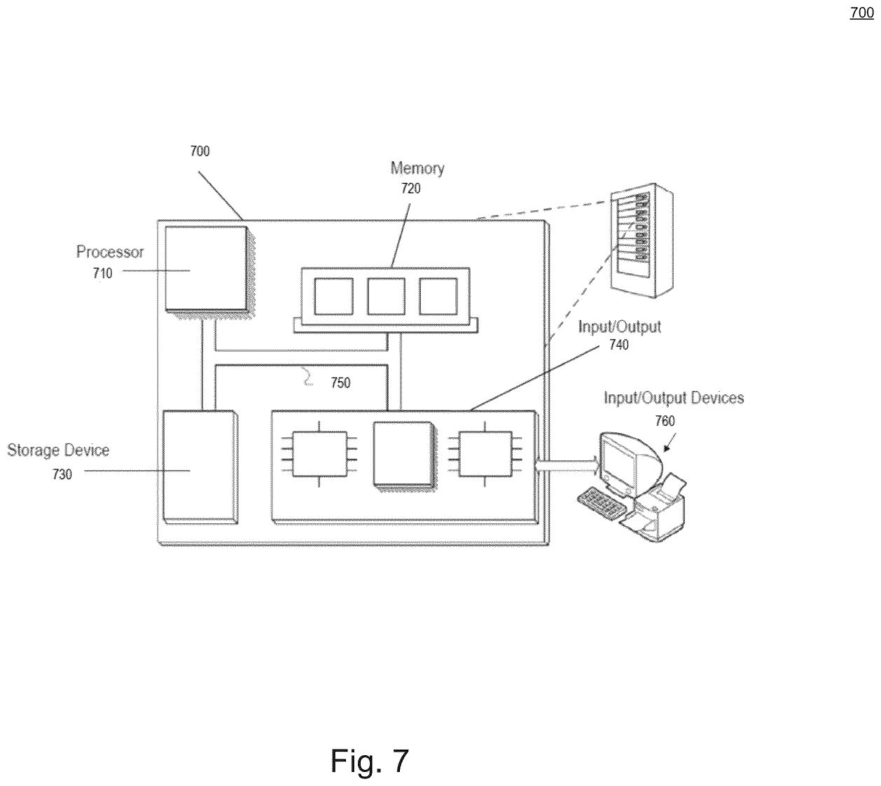

FIG. 7 is a block diagram of an example computer system 700 that may be used in implementing the technology described in this disclosure (e.g., any of the devices and/or systems illustrated in FIG. 7; the components or modules or a risk-mitigated intelligent agent 105, a system 100 for risk detection and/or mitigation, or an intelligent agent 110; the steps of the methods illustrated in FIGS. 2-6; etc.). General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large capacity storage device. For example, the storage device may store long-term data (e.g., database data, file system data, etc.). The input/output device 740 provides input/output operations for the system 700. In some implementations, the input/output device 740 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 760. In some examples, mobile computing devices, mobile communication devices, and other devices may be used.

FIG. 8 illustrates a method for fault detection and mitigation for aggregate models using artificial intelligence, according to some embodiments. At least one of the systems 100 or 102 can perform method 800 according to present implementations. The method 800 can begin at step 810.

The system 100 or 100B can perform method 800 according to present implementations. The method 800 can begin at 810. 810 can include at least one of 812 and 814. At 812, the method can obtain a request to identify a probability of a fault in an aggregate model. At 814, the method can obtain a request to identify a probability of a fault in an aggregate model via an input at a user interface. The method 800 can then continue to 820.

At 820, the method can generate first data by a second model. A second model can include a model compatible with input data including one of or a subset of data 302A-N. 820 can include at least one of 822 and 824. At 822, the method can generate first data by a second model trained by machine learning. At 824, the method can generate first data by a second model compatible with a first data of a first type. The method 800 can then continue to 830.

At 830, the method can generate second data by a third model. A second model can include a model compatible with input data including one of or a subset of data 302A-N that is distinct from the compatibility of the second model. 830 can include at least one of 832 and 834. At 832, the method can generate second data by a third model trained by machine learning. At 834, the method can generate second data by a third model compatible with second data of a second type. The method 800 can then continue to 902.

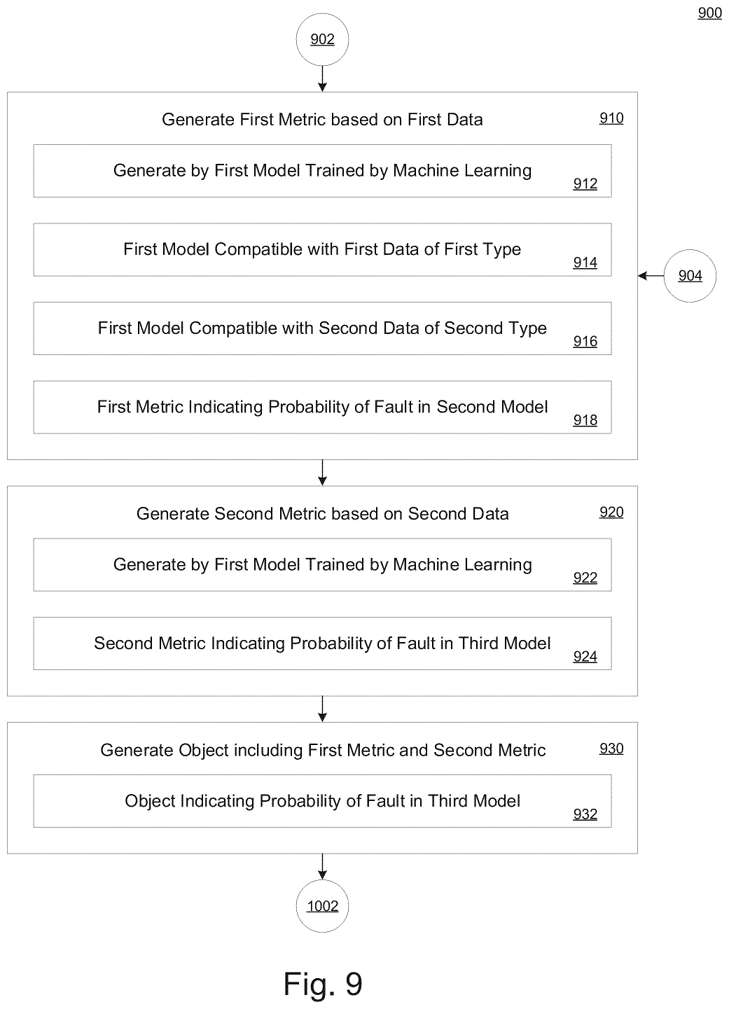

FIG. 9 illustrates a method for fault detection and mitigation for aggregate models using artificial intelligence, according to some embodiments. At least one of the systems 100 or 102 can perform method 900 according to present implementations. The method 900 can begin at step 902. The method 900 can then continue to step 910.

The system 100 or 100B can perform method 900 according to present implementations. The method 900 can begin at 902. The method 900 can then continue to 910.

At 910, the method can generate a first metric based on first data. 910 can include at least one of 912, 914, 916, and 918. At 912, the method can generate a first metric by a first model trained by machine learning. A first model can include a model compatible with or operable to perform multi-modal preprocessing 303, for example. At 914, the method can generate a first metric by a first model compatible with first data of a first type. At 916, the method can generate a first metric by a first model compatible with second data of a second type. At 918, the method can generate a first metric indicating probability of fault in second model. The method 900 can then continue to 920.

At 920, the method can generate a second metric based on second data. 920 can include at least one of 922 and 924. At 922, the method can generate a second metric by a first model trained by machine learning. At 924, the method can generate a second metric indicating a probability of fault in a third model. The method 900 can then continue to 930.

At 930, the method can generate an object including the first metric and the second metric. 930 can include 932. At 932, the method can generate an object indicating a probability of fault in third model. The method 900 can then continue to 1002.

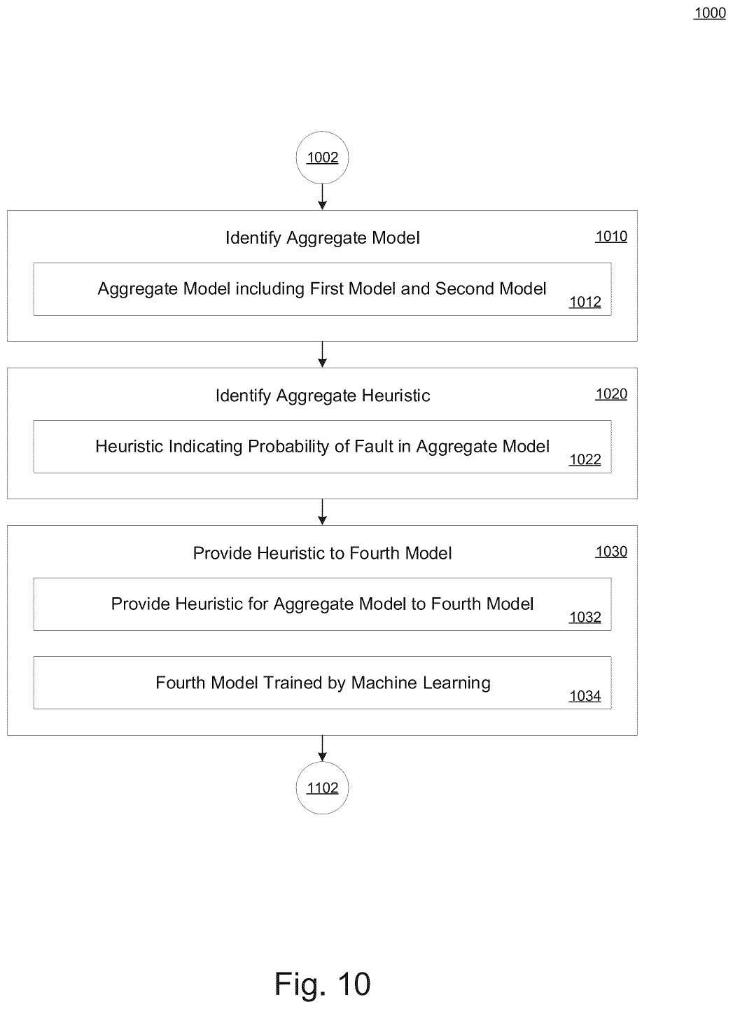

FIG. 10 illustrates a method for fault detection and mitigation for aggregate models using artificial intelligence, according to some embodiments. At least one of the systems 100 or 102 can perform method 1000 according to present implementations. The method 1000 can begin at step 1002. The method 1000 can then continue to step 1010.

The system 100 or 100B can perform method 1000 according to present implementations. The method 1000 can begin at 1002. The method 1000 can then continue to 1010.

At 1010, the method can identify an aggregate model. 1010 can include 1012. At 1012, the method can identify an aggregate model including or referencing a first model and a second model. The first model and the second model can include any two models, for example, of the aggregate model. The method 1000 can then continue to 1020.

At 1020, the method can identify an aggregate heuristic. 1020 can include 1022. At 1022, the method can identify an aggregate heuristic indicating probability of fault in an aggregate model. The method 1000 can then continue to 1030.

At 1030, the method can provide a heuristic to a fourth model. The fourth model can include, for example, a model configured to perform evaluation in accordance with 307. 1030 can include at least one of 1032 and 1034. At 1032, the method can provide a heuristic corresponding to an aggregate model to a fourth model. At 1034, the method can provide a heuristic to a fourth model trained by machine learning. The method 1000 can then continue to 1102.

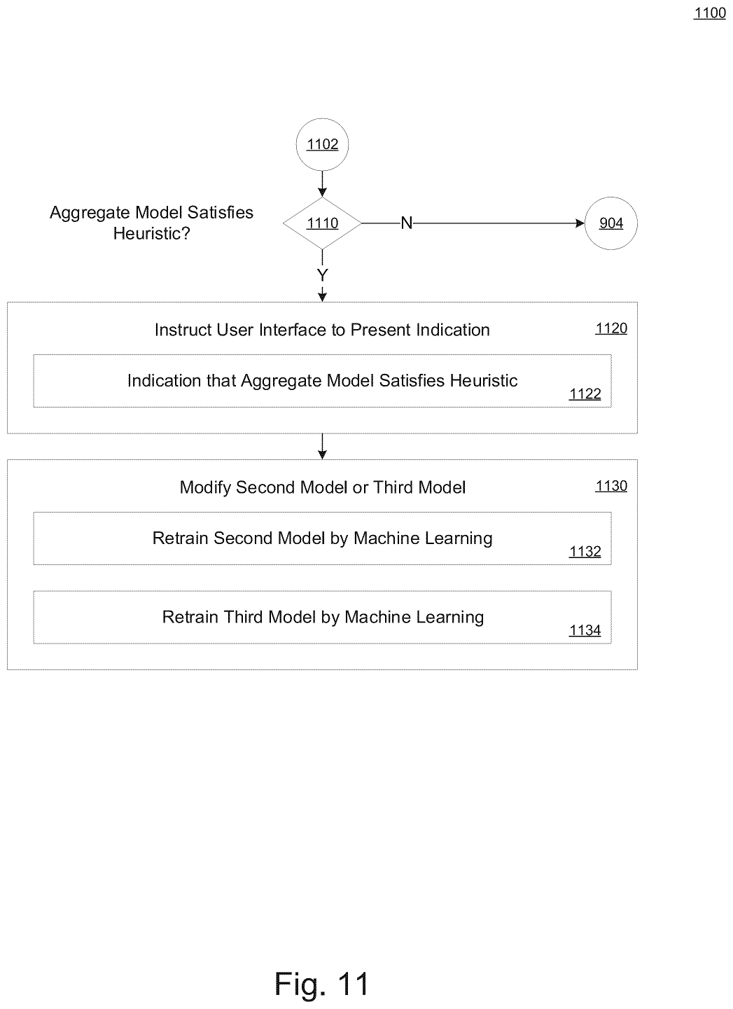

FIG. 11 illustrates a method for fault detection and mitigation for aggregate models using artificial intelligence, according to some embodiments. At least one of the systems 100 or 102 can perform method 1100 according to present implementations. The method 1100 can begin at step 1102. The method 1100 can then continue to step 1110.

The system 100 or 100B can perform method 1100 according to present implementations. The method 1100 can begin at 1102. The method 1000 can then continue to 1110.

At 1110, the method can determine whether the aggregate model satisfies the heuristic. In accordance with a determination that the aggregate model satisfies the heuristic, the method 1100 can continue to 1120. Alternatively, in accordance with a determination that the aggregate model does not satisfy the heuristic, the method 1100 can continue to 904.

At 1120, the method can instruct a user interface to present an indication. 1120 can include 1122. At 1122, the method can instruct a user interface to present an indication that an aggregate model satisfies a heuristic. The method 1100 can then continue to 1130.

At 1130, the method can modify a second model or a third model. 1130 can include at least one of 1132 and 1134. At 1132, the method can retrain a second model by machine learning. At 1134, the method can retrain a third model by machine learning. The method 1100 can end at 1130.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 730 may be implemented in a distributed way over a network, for example as a server farm or a set of widely distributed servers, or may be implemented in a single computing device.

Although an example processing system has been described in FIG. 7, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a laptop, a mobile telephone, a personal digital assistant (PDA), a smartphone, a mobile audio or video player, a game console, a Global Positioning System (GPS) receiver, a portable storage device (e.g., a universal serial bus (USB) flash drive), a smart watch, a network connected sensor, a camera, a smart speaker, a vehicle, an automated teller machine, a network connectivity device, an alarm system, a defense system, any combination of the foregoing, etc.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system comprising:
a data processing system comprising memory and one or more processors to:
generate, by a first model trained using machine learning and compatible with first data having a first type and second data having a second type, a first metric based on the first data and indicative of a first probability of a fault in a second model;
generate, by the first model, a second metric based on the second data and indicative of a second probability of a fault in a third model;
determine, based on the first metric and the second metric, that an aggregate model that includes the second model and the third model satisfies a heuristic indicative of a third probability of a fault in the aggregate model; and
instruct, in response to a determination that the aggregate model satisfies the heuristic, a user interface to present an indication that the aggregate model satisfies the heuristic.

2. The system of claim 1, the first data generated by the second model, and the second model trained using machine learning and compatible with the first type.

3. The system of claim 1, the second data generated by the third model, and the third model trained using machine learning and compatible with the second type.

4. The system of claim 1, the data processing system to:
generate an object that comprises the first metric and the second metric and indicative of the first probability and the second probability; and
provide the object to a fourth model as input.

5. The system of claim 1, the data processing system to:
modify, in response to the determination that the aggregate model satisfies the heuristic, at least one of the second model and the third model.

6. The system of claim 1, the fault in the second model corresponding to a drift in the second model, and the fault in the third model corresponding to a drift in the third model.

7. The system of claim 6, the fault in the aggregate model corresponding to a drift in the aggregate model, and the heuristic corresponding to a predetermined drift in the aggregate model.

8. The system of claim 1, the determination that the aggregate model satisfies the heuristic is performed by a fourth model trained using a machine learning model.

9. The system of claim 1, the determination that the aggregate model satisfies the heuristic is performed by a fourth model comprising a regression model.

10. The system of claim 1, the data processing system to:
obtain, via the user interface, input indicative of a request to identify the fault in the aggregate model; and
instruct the user interface to present the indication in response to the obtained input.

11. A method comprising:
generating, by a first model trained using machine learning and compatible with first data having a first type and second data having a second type, a first metric based on the first data and indicating a first probability of a fault in a second model;
generating, by the first model, a second metric based on the second data and indicating a second probability of a fault in a third model;
determining, based on the first metric and the second metric, that an aggregate model including the second model and the third model satisfies a heuristic indicating a third probability of a fault in the aggregate model; and
instructing, in response to the determining that the aggregate model satisfies the heuristic, a user interface to present an indication that the aggregate model satisfies the heuristic.

12. The method of claim 11, the first data generated by the second model, and the second model trained using machine learning and compatible with the first type.

13. The method of claim 11, the second data generated by the third model, and the third model trained using machine learning and compatible with the second type.

14. The method of claim 11, comprising:
generating an object comprising the first metric and the second metric and indicating the first probability and the second probability; and
provide the object to a fourth model as input.

15. The method of claim 11, comprising:
modify, in response to the determination that the aggregate model satisfies the heuristic, at least one of the second model and the third model.

16. The method of claim 11, the fault in the second model corresponding to a drift in the second model, and the fault in the third model corresponding to a drift in the third model.

17. The method of claim 16, the fault in the aggregate model corresponding to a drift in the aggregate model, and the heuristic corresponding to a predetermined drift in the aggregate model.

18. The method of claim 11, comprising:
obtaining, via the user interface, input indicating a request to identify the fault in the aggregate model; and
instruct the user interface to present the indication in response to the obtained input.

19. A computer readable medium including one or more instructions stored thereon and executable by a processor to:
generate, by the processor with a first model trained using machine learning and compatible with first data having a first type and second data having a second type, a first metric based on the first data and indicative of a first probability of a fault in a second model;
generate, by the processor with the first model, a second metric based on the second data and indicative of a second probability of a fault in a third model;
determine, by the processor and based on the first metric and the second metric, that an aggregate model that includes the second model and the third model satisfies a heuristic indicative of a third probability of a fault in the aggregate model; and
instruct, by the processor in response to a determination that the aggregate model satisfies the heuristic, a user interface to present an indication that the aggregate model satisfies the heuristic.

20. The computer readable medium of claim 19, the first data generated by the second model, the second model trained using machine learning and compatible with the first type, the second data generated by the third model, and the third model trained using machine learning and compatible with the second type.
